(19) United States
(12) Patent Application Publication
(10) Pub. No.: US 2024/0220700 A1
(43) Pub. Date: Jul. 4, 2024

(54) PROCESS MODEL GENERATING METHOD, PROCESS PROXIMITY CORRECTION METHOD, AND COMPUTING DEVICE THEREFOR

(71) Applicant: Samsung Electronics Co., Ltd., Suwon-si (KR)

(72) Inventors: Yangwoo Heo, Suwon-si (KR); Majd Kuteifan, Suwon-si (KR); Mindy Lee, Suwon-si (KR); SOOYONG LEE, Suwon-si (KR); JEEYONG LEE, Suwon-si (KR)

(21) Appl. No.: 18/210,836

(22) Filed: Jun. 16, 2023

(30) Foreign Application Priority Data
Jan. 3, 2023 (KR) 10-2023-0000760

(51) Int. Cl. G06F 30/392

(52) U.S. Cl. CPC G06F 30/392; G06F 2119/02

(57) ABSTRACT

Provided is a process model generating method including: obtaining a target layout for a process of a semiconductor device and a plurality of sublayers representing a substructure of the semiconductor device; determining a lateral feature and a vertical feature of the target layout; and generating a correction model for the target layout based on the lateral feature and the vertical feature.

### CROSS-REFERENCE TO RELATED APPLICATION

This application claims priority to and the benefit thereof under 35 U.S.C. § 119 to Korean Patent Application No. 10-2023-0000760, filed in the Korean Intellectual Property Office on Jan. 3, 2023, the entire contents of which are incorporated herein by reference.

### BACKGROUND

### (a) Field

The present disclosure relates to a process model generating method, a process proximity correction method, and a computing device therefor.

### (b) Description of the Related Art

A semiconductor process for manufacturing a semiconductor device may be implemented by a combination of various procedures such as etching, depositing, planation, growth, implanting, and the like. Etching may be performed by forming a photoresist pattern on an object, and removing portions of the object not covered by the photoresist pattern by using chemicals, gas, plasma, ion beam, or the like.

A process error may occur due to various factors in the process of performing etching. The factors that cause the process error may be due to a process characteristic, or may be due to a characteristic of a semiconductor pattern implemented by the photoresist pattern or etching. The process error due to the characteristic of the pattern may be compensated for by correcting or changing a layout of the pattern.

The number of patterns included in the semiconductor layout has been rapidly increased in accordance with a higher degree of integration of the semiconductor device and a finer semiconductor process. Therefore, an amount of calculation for correcting or changing the layout of the pattern to compensate for the process error is also increased rapidly, which leads to emergence of process proximity correction (PPC) using machine learning (ML).

### SUMMARY

An embodiment may provide a process proximity correction (PPC) model generating method for performing process proximity correction (PPC) stably and effectively.

Another embodiment may provide a process proximity correction (PPC) method for performing process proximity correction (PPC) stably and effectively by using a PPC model.

Still another embodiment may provide a computing device for generating a process proximity correction (PPC) model and performing PPC stably and effectively.

According to an embodiment, a process model generating method includes: obtaining a target layout for a process of manufacturing a semiconductor device and a plurality of sublayers representing a substructure of the semiconductor device; determining the lateral feature and vertical feature of the target layout; and generating a correction model for the target layout based on the lateral feature and the vertical feature.

The determining of the lateral feature and the vertical feature of the target layout may include: generating an evaluation point on the target layout; and determining the lateral feature and the vertical feature of the evaluation point.

The lateral feature may be a feature of the evaluation point for the target layout, and the vertical feature may include information on the sublayer in contact with a vertical line of the evaluation point for the target layout among the plurality of sublayers.

The determining of the lateral feature and the vertical feature of the evaluation point may include: determining a vector value of the sublayer in contact with the vertical line among the plurality of sublayers as 1, and determining a vector value of a sublayer not in contact with the vertical line among the plurality of sublayers as 0.

The generating of the evaluation point may include: generating at least one evaluation point at a center of at least one segment of a pattern in the target layout, wherein a number of the at least one evaluation point may be less than or equal to a number of the at least one segment of the pattern.

The generating of the correction model may include: generating a first model by using linear regression on the lateral feature and the vertical feature; and generating a second model by using machine learning on the first model.

The generating of the first model may include: obtaining a real skew of the target layout; and performing the linear regression on the real skew, the lateral feature, and the vertical feature, wherein the real skew is a difference between an after-development inspection-critical dimension (ADI-CD) and an after-cleaning inspection-critical dimension (ACI-CD).

The generating of the first model may include: generating the first model by obtaining coefficients Cₗᵢ and Cₛⱼ of the following Equation by using the linear regression,

$$skew\_real = \sum {c}_{li} * laternal\_i + \sum {c}_{sj} * sublayer\_j$$

wherein skew_real is the real skew, lateral_i is a value of an i-th lateral feature, Cₗᵢ is a coefficient for the lateral_i, sublayer_j is a value for whether a j-th sublayer exists among the plurality of sublayers, and Cₛⱼ is a coefficient for the sublayer_j.

The generating of the second model may include: calculating a predicted skew from the lateral feature and the vertical feature by using the first model; calculating a first residue skew that is a difference between the real skew and the predicted skew; and performing the machine learning by using the lateral feature, the vertical feature, and the first residue skew, wherein the lateral feature and the vertical feature are input data of a learning data set, and the first residue skew is output data of the learning data set.

The method may further include: inferring a second residue skew by using the second model; determining a final skew based on the predicted skew and the second residue skew; and generating a prediction layout for the target layout based on the target layout and the final skew.

The method may further include: generating a prediction layout from an initial layout by using the correction model; determining a separation distance between the prediction layout and the target layout; and correcting the initial layout based on the separation distance.

The correcting of the initial layout may include performing correction when the separation distance between the prediction layout and the target layout has a value greater than or equal to a threshold value.

The correcting of the initial layout may include correcting a position of the segment in the initial layout and a position of the evaluation point based on the separation distance.

The correcting of the initial layout may include correcting the position of the segment in the initial layout and the position of the evaluation point based on a value obtained by multiplying the separation distance by a predetermined factor, and wherein the predetermined factor may be a decimal less than 1.

The determining of the lateral feature and the vertical feature of the target layout may include: determining the sublayer on which the lateral feature is operated among the plurality of sublayer; and updating the lateral feature based on the determined sublayer.

According to another embodiment, a process proximity correction method may include: generating a correction model based on a lateral feature and a vertical feature of an after-cleaning inspection (ACI) target layout; generating an ACI prediction layout from an after-development inspection (ADI) layout by using the correction model; correcting the ADI layout based on a first difference between the ACI prediction layout and the ACI target layout, wherein the vertical feature is associated with the presence or absence of a sublayer in a substructure.

The generating of the correction model may include: determining a vector value of the vertical feature as a first value when the sublayer corresponding to the target layout exists in the substructure, and determining a vector value of the vertical feature as a second value different from the first value when no sublayer corresponding to the target layout exists in the substructure.

The generating of the correction model may include generating the correction model by performing linear regression and machine learning on the lateral feature and the vertical feature.

The correcting of the ADI layout may include: generating a first corrected layout by correcting the ADI layout based on a value obtained by multiplying the first difference by a first factor; obtaining a second difference between the ACI target layout and the first corrected layout; and generating a second corrected layout by correcting the first corrected layout based on a value obtained by multiplying the second difference by a second factor, wherein the second factor is smaller than the first factor.

According to still another embodiment, a computing device includes a plurality of processors, wherein at least one of the plurality of processors generates a correction model for process proximity correction, and wherein when the at least one of the plurality of processors generates the correction model for the process proximity correction, the at least one of the plurality of processors generates is configured to: obtain a target layout for a process of a semiconductor device and a plurality of sublayers representing a substructure of the semiconductor device; determine a lateral feature and a vertical feature of the target layout; and generate the correction model based on the lateral feature and the vertical feature.

According to an embodiment, a method of manufacturing a semiconductor device comprises: obtaining a target layout for a process of manufacturing the semiconductor device and a plurality of sublayers representing a substructure of the semiconductor device; determining a lateral feature and a vertical feature of the target layout; generating a correction model for the target layout based on the lateral feature and the vertical feature; and forming the semiconductor device based on the correction model.

According to an embodiment, a method of manufacturing a semiconductor device comprises: generating a correction model based on a lateral feature and a vertical feature of an after-cleaning inspection (ACI) target layout; generating an ACI prediction layout from an after-development inspection (ADI) layout by using the correction model; correcting the ADI layout based on a first difference between the ACI prediction layout and the ACI target layout; and forming the semiconductor device based on the corrected ADI layout, wherein the vertical feature is associated with a presence or an absence of a sublayer in a substructure.

### BRIEF DESCRIPTION OF THE DRAWINGS

FIG. 1 is a block diagram showing a computing device according to an example embodiment.

FIG. 2 is a view for explaining a lateral feature of a semiconductor device according to an example embodiment.

FIG. 3 is a view for explaining the lateral feature of the semiconductor device according to an example embodiment.

FIG. 4 is a view for explaining the lateral feature of the semiconductor device according to an example embodiment.

FIG. 5 is a view for explaining the vertical feature of the semiconductor device according to an example embodiment.

FIG. 6 is a view for explaining a configuration in which a correction module performs process proximity correction and optical proximity correction according to an example embodiment.

FIG. 7 is a view for explaining the configuration in which the correction module performs the process proximity correction and the optical proximity correction according to an example embodiment.

FIG. 8 is a view for explaining the configuration in which the correction module performs the process proximity correction and the optical proximity correction according to an example embodiment.

FIG. 9 is a view for explaining an etching pattern formed in an etching process according to an example embodiment.

FIG. 10 is a view for explaining the etching pattern formed in the etching process according to an example embodiment.

FIG. 11 is a view for explaining the etching pattern formed in the etching process according to an example embodiment.

FIG. 12 is a view for explaining the etching pattern formed in the etching process according to an example embodiment.

FIGS. 13A and 13B are views for explaining a configuration in which a semiconductor process module determines the vertical feature of the semiconductor device according to an example embodiment.

FIG. 14 is a view for explaining a configuration in which a machine learning module performs linear regression and machine learning according to an example embodiment.

FIG. 15 is a view for explaining the configuration in which the machine learning module performs the linear regression and the machine learning according to an example embodiment.

FIG. 16 is a view for explaining an operation of the correction module according to an example embodiment.

FIG. 17 is a view for explaining a configuration in which the machine learning module performs the linear regression and the machine learning according to an example embodiment.

FIG. 18 is a view for explaining the configuration in which the machine learning module performs the linear regression and the machine learning according to an example embodiment.

FIG. 19 is a flowchart of a process model generating method according to an example embodiment.

FIG. 20 is a flowchart of a process proximity correction method according to an example embodiment.

FIG. 21 shows graphs for explaining an effect of the machine learning module according to an example embodiment.

FIG. 22 shows graphs for explaining the effect of the machine learning module according to an example embodiment.

FIG. 23 is a flowchart of a method of manufacturing a semiconductor device using a photomask optimized according to example embodiments.

### DETAILED DESCRIPTION OF THE EMBODIMENTS

Hereinafter, example embodiments are described in detail with reference to the accompanying drawings so that those skilled in the art to which the present disclosure pertains may easily practice the present disclosure. However, the present disclosure may be modified in various different forms, and is not limited to the embodiments provided in the specification.

In addition, in the drawings, portions unrelated to the description are omitted to clearly describe the present disclosure, and similar portions are denoted by similar reference numerals throughout the specification. In a flowchart shown with reference to the drawings, an order of operations may be changed, several operations may be merged with each other, a certain operation may be divided, and a certain operation may not be performed.

In addition, a term of a single number may be interpreted as the single number or its plural number unless explicitly expressed such as “one” or “single.” Terms including ordinal numbers such as “first,” “second,” and the like may be used to describe various components. However, these components are not limited by these terms. These terms may be used to distinguish one component from another component.

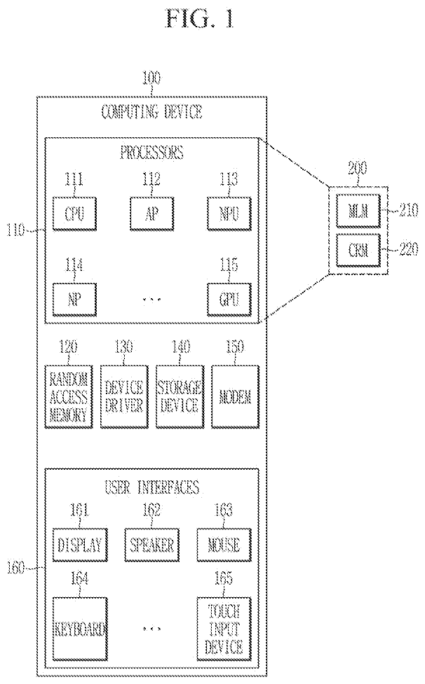

FIG. 1 is a block diagram showing a computing device according to an example embodiment.

Referring to FIG. 1, a computing device 100 may include processors 110, a random access memory 120, a device driver 130, a storage device 140, a modem 150, and user interfaces 160.

At least one of the processors 110 may perform a semiconductor process module 200. The semiconductor process module 200 may perform a machine learning module (MLM) 210 and a correction module (CRM) 220. The machine learning module 210 and the correction module 220 may generate a layout for manufacturing a semiconductor device based on machine learning.

The machine learning module 210 may generate a semiconductor process model for generating a photomask layout in a semiconductor process. The semiconductor process model may include a process proximity correction (PPC) model (i.e., PPC model) and an optical proximity correction (OPC) model (i.e., OPC model). The photomask layout may be generated by using the OPC model after using the PPC model.

The PPC is a work to correct a skew that occurs in an etching process after a photo process, and it is important that the PPC model effectively simulates a real skew for this operation. The skew represents a difference between an after-development inspection (ADI)-critical dimension (CD) and an after-cleaning inspection (ACI)-critical dimension (CD). The critical dimension (CD) may indicate a width of a pattern line. The machine learning module 210 may generate the PPC model that effectively simulates the real skew. The PPC model may generate an ACI prediction layout based on an ADI layout and the skew corresponding to the ADI layout. The ADI layout may indicate a photoresist layout. The ACI prediction layout may be compared with a layout desired to be obtained when performing the ACI, i.e., ACI target layout, and the ADI layout may be corrected based on a comparison result.

The PPC model may include a feature-based etch model. The feature-based etch model may define a relationship between the lateral feature and vertical feature of the semiconductor device and the skew. For example, the feature-based etch model may be used to thus determine the skew at an evaluation point based on the lateral feature and vertical feature of the pattern in the layout at the evaluation point. The evaluation point may be positioned at the center of a segment of the pattern. The segment may indicate an edge of the pattern, and the pattern may include the plurality of segments. For example, when the pattern has a polygon shape, the segment may indicate a side of the polygon. For example, the pattern may have as many evaluation points as the number of segments, but the embodiments are not limited thereto, and the pattern may be implemented as having the evaluation points whose number is less than the number of segments. The lateral feature and vertical feature may be obtained from design data. The design data may include a target layout and a lower layout indicating a substructure. In the lower layout, for example, the design data may be data of a graphic design system (GDS).

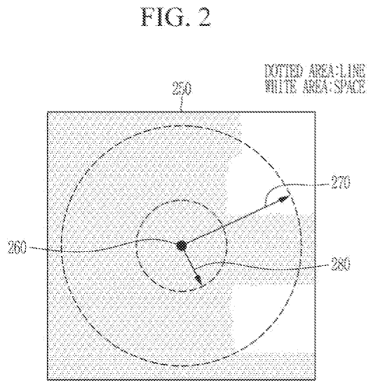

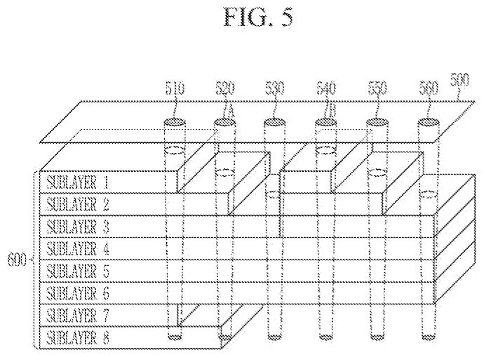

The lateral feature may include the density, visible area, width, space, length, and the like of the pattern in the ACI target layout. The lateral feature is described below with reference to FIGS. 2 to 4. The vertical feature may be associated with a substructure of the semiconductor device before the etching process. The vertical feature may include the presence or absence of a sublayer corresponding to the evaluation point of the ACI target layout. For example, the substructure may include the plurality of sublayers, and the vertical feature may include information on whether the sublayer corresponding to the evaluation point exists in a direction perpendicular to the ACI target layout. The vertical feature is described below with reference to FIG. 5.

The machine learning module 210 may generate the PPC model by using linear regression and the machine learning. The machine learning module 210 may use the linear regression for the lateral feature, the vertical feature, and the real skew. The machine learning module 210 may obtain the real skew by inspecting an actual wafer on which the semiconductor process is already performed. The machine learning module 210 may determine coefficients of the lateral feature and the vertical feature of the real skew by using the linear regression.

The machine learning module 210 may calculate a predicted skew from the lateral feature and vertical feature based on the coefficients determined by the linear regression. The machine learning module 210 may calculate a residue skew, which is a difference between the real skew and the predicted skew. The machine learning module 210 may perform the machine learning by using the lateral feature, the vertical feature, and the residue skew. For example, the machine learning module 210 may use a learning data set having the lateral and vertical features as input data and the residue skew as output data for the machine learning. The machine learning module 210 that completes the learning may infer the residue skew from the lateral and vertical features. Therefore, the PPC model generated by the linear regression and the machine learning may determine the skew stably and effectively by reflecting the predicted skew and the residue skew, obtained from the lateral and vertical features, and may generate the ACI prediction layout from the ADI layout based on the determined skew.

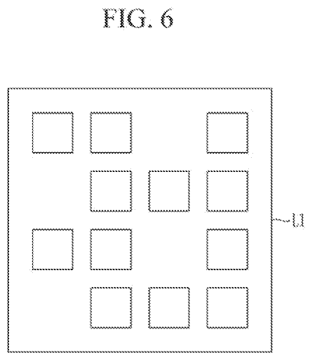

The correction module 220 may generate a layout for manufacturing the semiconductor device by using the semiconductor process model generated by the machine learning module 210. For example, the correction module 220 may generate the ADI layout (photoresist layout) by using the PPC model during the PPC work, and generate the photomask layout by using the OPC model during the OPC work. A configuration in which the correction module 220 generates the layout is described below with reference to FIGS. 6 to 8.

The correction module 220 may generate the ADI layout from the ACI target layout through the PPC work. The correction module 220 may perform the PPC work by using the PPC model generated by the machine learning module 210. The PPC model may generate the ACI prediction layout from the ADI layout. In an embodiment, an initial ADI layout may be the ACI target layout, but the initial ADI layout is not necessarily limited thereto, and any ADI layout may be used as the initial ADI layout. The correction module 220 may correct the ADI layout based on a difference between the ACI prediction layout and the ACI target layout. The correction module 220 may repeatedly perform the correction until the difference between the ACI prediction layout and the ACI target layout becomes less than a reference value. The correction module 220 may perform the OPC work by using the ADI layout for which the PPC work is already completed.

In an embodiment, the machine learning module 210 and the correction module 220 may be implemented in the form of instructions (or codes) performed by at least one of the processors 110. For example, the machine learning module (MLM) 210 and the correction module (CRM) 220 may each correspond to a separate segment or segments of software (e.g., a subroutine) which configure one or more of the processors 110, and/or may correspond to segment(s) of software that also correspond to one or more other functional modules described herein (e.g., the functional modules may share certain segment(s) of software or be embodied by the same segment(s) of software). As is understood, “software” refers to prescribed rules to operate a computer, such as instructions or codes. Here, at least one processor 110 may load the instructions (or codes) of the machine learning module 210 and the correction module 220 into the random access memory 120.

In another embodiment, at least one of the processors 110 may be manufactured to implement the machine learning module 210 and the correction module 220. In another embodiment, at least one of the processors 110 may be manufactured to implement various machine learning modules. At least one of the processors 110 may implement the machine learning module 210 and the correction module 220 by receiving information corresponding to the machine learning module 210 and the correction module 220.

The processors 110 may include, for example, at least one general-purpose processor such as a central processing unit (CPU) 111 or an application processor (AP) 112. The processors 110 may also include at least one special-purpose processor such as a neural processing unit (NPU) 113, a neuromorphic processor (NP) 114, or a graphics processing unit (GPU) 115. The processors 110 may include two or more processors of the same type.

The random access memory 120 may be used as an operation memory of the processors 110, or may be used as the main memory or system memory of the computing device 100. The random access memory 120 may include a volatile memory such as a dynamic random access memory or a static random access memory, or a non-volatile memory such as a phase change random access memory, a ferroelectric random access memory, a magnetic random access memory, or a resistive random access memory.

The device driver 130 may control peripheral devices such as the storage device 140, the modem 150, and the user interfaces 160 based on requests from the processors 110. The storage device 140 may include a storage device such as a fixed storage device such as a hard disk drive (HDD) or a solid state drive (SSD), or a removable storage device such as an external hard disk drive, an external solid state drive, or a removable memory card.

The modem 150 may provide remote communication with an external device. The modem 150 may perform wireless or wired communication with the external device. The modem 150 may communicate with the external device through at least one of various communication methods such as, for example, Ethernet, wireless-fidelity (Wi-Fi), a long term evolution (LTE), 5th generation (5G) mobile communication, etc.

The user interfaces 160 may each receive information from a user and provide information to the user. The user interfaces 160 may include at least one user output interface such as, for example, a display 161 or a speaker 162, and at least one user input interface such as, for example, a mouse 163, a keyboard 164, or a touch input device 165.

The instructions (or codes) of the machine learning module 210 and those of the correction module 220 may be received through the modem 150 and stored in the storage device 140. The instructions (or codes) of the machine learning module 210 and those of the correction module 220 may be stored in the removable storage device and coupled to the computing device 100. The instructions (or codes) of the machine learning module 200 may be performed by being loaded into the random access memory 120 from the storage device 140.

FIGS. 2 to 4 are views for explaining the lateral feature of the semiconductor device according to an example embodiment. Layouts 250, 300, and 400 shown in FIGS. 2 to 4 may be parts of the ACI target layout.

Referring to FIGS. 1 and 2, the processors 110 according to an example embodiment may determine the density among the lateral features of the semiconductor device. For example, the processors 110 may determine the density of the layout 250 by executing the semiconductor process module 200. The layout 250 may include an evaluation point 260. The semiconductor process module 200 may determine the density based on the evaluation point 260 and a first radius 270 or a second radius 280. The first radius 270 may be greater than the second radius 280. Whether to use the first radius 270 or the second radius 280 may be predetermined based on the semiconductor process or the like.

The semiconductor process module 200 may determine the density of the evaluation point 260 based on a ratio of a line to a space inside a circle generated based on the first radius 270 or the second radius 280 on the basis of the evaluation point 260. The density may have a value between zero and 1. For example, the semiconductor process module 200 may determine that 0.85 is the density of the first radius 270 and 1 is the density of the second radius 280.

In an embodiment, the semiconductor process module 200 may determine the density by using a pre-designed density map when determining the density by using the evaluation point 260 and the first radius 270. For example, the first radius 270 may be greater than or equal to 10 micrometers (um).

In an embodiment, the semiconductor process module 200 may determine the density by using a kernel method when determining the density by using the evaluation point 260 and the second radius 280. For example, the semiconductor process module 200 may determine the density by using a Gaussian kernel method.

The above-described embodiment describes a configuration for determining the density by using a different method when the radius is different, the present disclosure is not necessarily limited thereto, and may be implemented as having a configuration for determining the density by using the same method.

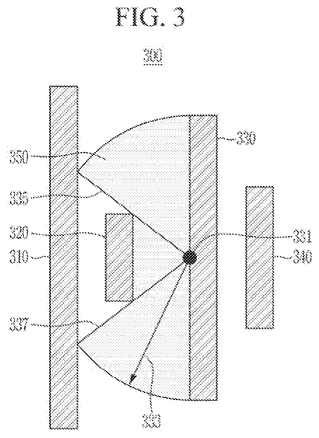

Referring to FIGS. 1 and 3, the processors 110 according to an example embodiment may determine the visible area among the lateral features of the semiconductor device. For example, the processors 110 may determine a value of the visible area in the layout 300 by executing the semiconductor process module 200. The layout 300 may include patterns 310, 320, 330, and 340.

The semiconductor process module 200 may generate a circle based on an evaluation point 331. A radius 333 of the circle may be determined based on a length of a segment of the pattern 330 where the evaluation point 331 is positioned. In an embodiment, the radius 333 of the circle may be substantially equal to half the length of the segment of the pattern 330, and is not necessarily limited thereto.

The semiconductor process module 200 may determine a visible region 350 of the evaluation point 331. The visible region 350 may exclude a region covered by the pattern 310, 320, or 330 from the circle generated based on the evaluation point 331. For example, the semiconductor process module 200 may generate two straight lines 335 and 337 toward an edge of the pattern 320 based on the evaluation point 331. For example, the semiconductor process module 200 may generate the straight line 335 passing through an upper edge of the pattern 320 from the evaluation point 331 to be in contact with the pattern 310, and the straight line 337 passing through a lower edge of the pattern 320 from the evaluation point 331 to be in contact with the pattern 310. The visible region 350 may include an area between the two straight lines 335 and 337 and the pattern 320. The visible region 350 may not include an area between the two straight lines 335 and 337 and the patterns 310 and 320.

The semiconductor process module 200 may determine a value of the visible area of the evaluation point 331 based on a ratio of an area of a semicircle to an area of the visible area 350 of the generated circle. For example, the semiconductor process module 200 may determine, as the value of the visible area of the evaluation point 331, a value obtained by dividing the area of the visible area 350 by the area of the semicircle. The visible area may have a value between zero and 1.

FIG. 3 shows the configuration in which the semiconductor process module 200 determines the visible area based on the areas of the semicircle and the visible region, positioned toward the outside of the pattern 330 from the evaluation point 331. However, the semiconductor process module 200 may also use, as the lateral feature, the visible area determined based on the semicircle and the visible region, positioned toward the inside of the pattern 330 from the evaluation point 331.

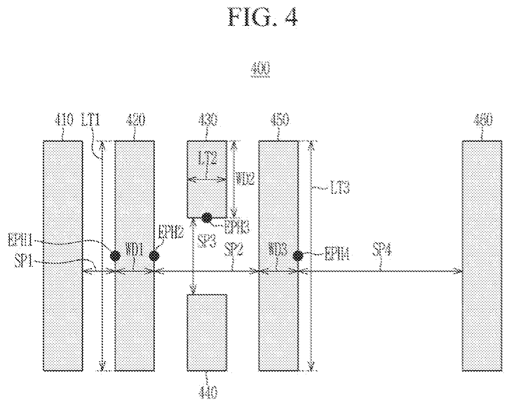

Referring to FIGS. 1 and 4, the processors 110 according to an example embodiment may determine the width, space, and length among the lateral features of the semiconductor device. The width may indicate a length of a vertical line of the evaluation point at a segment in the pattern. The space can indicate a distance to an adjacent pattern through which the vertical line passes from the evaluation point at the segment. The length may indicate a length of the segment where the evaluation point is positioned. For example, the processors 110 may determine the width, space, and length of the layout 400 by executing the semiconductor process module 200. The layout 400 may include patterns 410, 420, 430, 440, 450, and 460.

The semiconductor process module 200 may determine the width, space, and length of each of the evaluation points EPH1, EPH2, EPH3, and EPH4. For example, the semiconductor process module 200 may determine the width WD1, space SP1, and length LT1 of the evaluation point EPH1. The semiconductor process module 200 may determine the width WD2, space SP2, and length LT2 of the evaluation point EPH2. The semiconductor process module 200 may determine the width WD3, space SP3, and length LT3 of the evaluation point EPH3. The semiconductor process module 200 may determine the width WD3, space SP4, and length LT3 of the evaluation point EPH4.

In addition to the lateral features described with reference to FIG. 4, the semiconductor process module 200 may generate the semiconductor process model by using the lateral feature such as a pitch or an aspect ratio. The semiconductor process module 200 may generate the semiconductor process model by using a value derived through an operation between the lateral features. For example, the pitch may be a sum of the width and the space, and the aspect ratio may be a value obtained by dividing the width by the length.

The semiconductor process module 200 may generate the feature-based etch model by using the lateral feature described with reference to FIGS. 1 to 4.

FIG. 5 is a view for explaining the vertical feature of the semiconductor device according to an example embodiment. The layout 500 shown in FIG. 5 may be a part of the ACI target layout.

Referring to FIGS. 1 and 5, the processors 110 according to an example embodiment may determine the vertical feature corresponding to the layout 500 of the semiconductor device. The layout 500 may include evaluation points 510, 520, 530, 540, 550, and 560. The semiconductor device may include the substructure 600. The substructure 600 may include a plurality of sublayers SUBLAYER1 through SUBLAYER8. The vertical feature may include the presence or absence of the sublayers SUBLAYER1 through SUBLAYER8 respectively corresponding to the evaluation points 510, 520, 530, 540, 550, and 560 of the layout 500. The processors 110 perform the semiconductor process module 200 to determine the vertical feature at the layout 500 and the substructure 600. The semiconductor process module 200 may determine the vertical feature based on the design data.

The semiconductor process module 200 may determine the vertical feature by using a vector. For example, the semiconductor process module 200 may use one-hot encoding for dividing information into zero and 1. The semiconductor process module 200 may generate the feature-based etch model by using a vectorized vertical feature.

The semiconductor process module 200 may respectively determine the presence or absence of the sublayers SUBLAYER1 through SUBLAYER8 for the evaluation points 510, 520, 530, 540, 550, and 560 by using [SUBL1, SUBL2, . . . , and SUBLP]. Here, P may be a total number of sublayers positioned below the layout 500. Each of SUBL1, SUBL2, . . . , and SUBLP may have a value of zero or 1. In an embodiment, SUBLn (here, n is a natural number greater than or equal to 1 and less than or equal to P) may have the value of 1 when an n-th sublayer exists below the evaluation point, and the value of zero when the n-th sublayer does not exist below the evaluation point.

As shown in FIG. 5, the evaluation point 510 may have the vertical feature of [1, 1, 1, 1, 1, 1, 1, and 1]. The evaluation point 520 may have the vertical feature of [0, 1, 1, 1, 1, 1, 0, and 1]. The evaluation point 530 may have the vertical feature of [0, 0, 1, 1, 1, 1, 0, and 0]. The evaluation point 540 may have the vertical feature of [1, 1, 1, 1, 1, 1, 0, and 0]. The evaluation point 550 may have the vertical feature of [0, 1, 1, 1, 1, 1, 0, and 0]. The evaluation point 560 may have the vertical feature of [0, 0, 1, 1, 1, 1, 0, and 0].

In another example, the SUBLn may have the value of zero when the sublayer exists below the evaluation point, and may have the value of 1 when no sublayer exists below the evaluation point.

A conventional semiconductor process module fails to consider the vertical feature when generating a semiconductor process model to thus lack the stability and accuracy of the semiconductor process model. The semiconductor process module 200 according to an example embodiment may generate an accurate and stable model by generating the semiconductor process model by using the vertical feature of the substructure 600 including the plurality of sublayers SUBLAYER1 through SUBLAYER8.

FIGS. 6 to 8 are views for explaining a configuration in which the correction module performs the process proximity correction and the optical proximity correction according to an embodiment.

Referring to FIGS. 6 to 8, the correction module 220 may receive a first layout L1. For example, the first layout L1 may be the ACI target layout desired to be obtained during the after-cleaning inspection ACI.

The correction module 220 may generate a second layout L2 by executing the process proximity correction (PPC) on the first layout L1. The correction module 220 may generate the second layout L2 from the first layout L1 by using the machine learning. For example, the correction module 220 may perform the machine learning by using the machine learning module 210. The PPC may be performed by performing machine learning-based inference on the features of the patterns in the first layout L1. The second layout L2 may be a photoresist target layout desired to be obtained during the after-development inspection (ADI).

The PPC may compensate for deformation of a shape of a semiconductor pattern during the etching occurring due to influences of a characteristic of the pattern and the etching skew. For example, the PPC may compensate for the deformation of the shape of the pattern which may occur during the semiconductor process such as the etching by deforming a shape of a part of a specific pattern that is predicted to be deformed in advance and reflecting the same to the layout.

The correction module 220 may generate a third layout L3 by performing the optical proximity correction (OPC) on the second layout L2. The third layout L3 may be the photomask layout.

The OPC may compensate for deformation of a shape of a photoresist pattern during the photo process occurring due to influences of a characteristic of the pattern and the skew. For example, the OPC may compensate for the deformation of the shape of the pattern which may occur during the semiconductor process such as the photo process by deforming a shape of a part of a specific pattern that is predicted to be deformed in advance and reflecting the same to the layout.

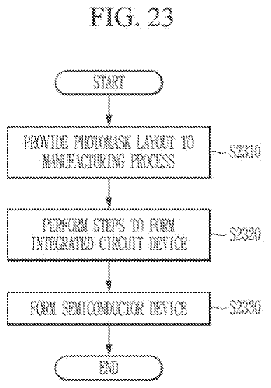

The semiconductor device may be produced (or manufactured) based on the third layout L3. For example, as discussed further in connection with FIG. 23, the photoresist pattern may be formed on an object (e.g., semiconductor process object manufactured as the semiconductor device) by using a photomask of the third layout L3. It is possible to remove exposed parts of the object that are not covered by the photoresist pattern through the etching. It is then possible to complete the semiconductor process by removing the photoresist.

FIG. 6 shows an example of the first layout L1. The first layout L1 may include rectangular patterns. For example, each of the rectangular patterns may be a via pattern. That is, the first layout L1 may be a layout for forming vias. The first layout L1 may be the ACI target layout desired to be obtained during the ACI, i.e., layout including a process pattern formed in the semiconductor process.

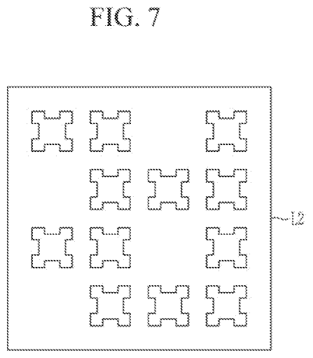

FIG. 7 shows an example of the second layout L2. A pattern in the second layout L2 of FIG. 7 may have a shape modified from that of the pattern in the first layout L1 of FIG. 6. The second layout L2 may be the target layout desired to be obtained during the ADI, i.e., layout including the photoresist pattern.

FIGS. 6 and 7 exemplify that the patterns are modified into the same shape. However, this example is provided only to make the spirit of the present disclosure readily understood. The patterns may be modified into different shapes.

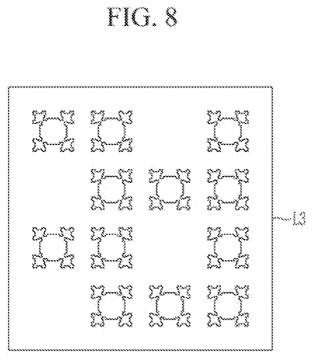

FIG. 8 shows an example of the third layout L3. A pattern in the third layout L3 of FIG. 8 may have a shape modified from that of the pattern in the second layout L2 of FIG. 7. The third layout L3 may be the photomask layout.

FIGS. 7 and 8 exemplify that the patterns are modified into the same shape. However, this example is provided only to make the spirit of the present disclosure readily understood. The patterns may be modified into different shapes.

The process proximity correction (PPC) may be a process of generating the second layout L2 of FIG. 7 from the first layout L1 of FIG. 6. The PPC may be performed on a feature-based basis. The feature-based PPC may be based on the lateral feature which is a geometric feature of the pattern and the vertical feature which is a substructure feature.

The machine learning module 210 according to an example embodiment may perform the PPC with improved accuracy and reduced computational effort by performing its learning and inference based on the image or feature of the pattern in the layout.

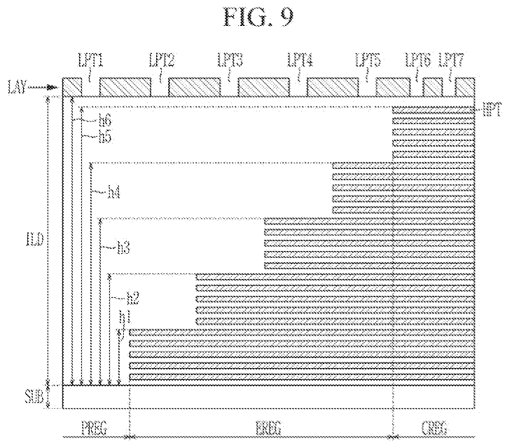

FIGS. 9 to 12 are views for explaining an etching pattern formed in the etching process according to example embodiments.

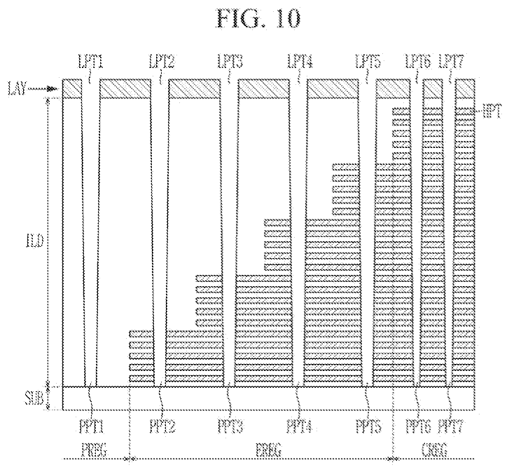

FIGS. 9 and 10 show an example of the semiconductor process. For example, FIGS. 9 and 10 show an example of the etching process for forming the process patterns, that is, etching patterns PPT1 to PPT7, by using a design layout LAY including layout patterns LTP1 to LTP7. Via contacts or NAND cell strings may be formed on the etching patterns PPT1 to PPT7 in a subsequent process. FIG. 9 shows a vertical structure of the semiconductor device before the etching process, and FIG. 10 shows the vertical structure of the semiconductor device after the etching process.

Referring to FIGS. 9 and 10, in a vertical NAND (VNAND) flash memory, hundreds of mold layers may be stacked in an upper area ILD of a semiconductor substrate SUB, and various single stack structures may be formed for switching for each word line.

For example, the upper area ILD may be made of silicon dioxide (SiO₂), and horizontal structure patterns HPT made of silicon nitride (SiN) may be positioned in silicon dioxide (SiO₂). A cell region (CREG) (or center region, CTREG) may have a multilayer structure formed by repeating alternately stacking silicon dioxide (SiO₂) and silicon nitride (SiN) on top of each other, and a peripheral region (PREG) may include only silicon dioxide (SiO₂). An extension region (EREG), which is an intermediate zone, may have a multilayer structure of various heights. The ACI CD after the etching process may depend on which mold the multilayer substructure uses even though the design layout LAY for the etching process has the same pattern. This difference may be mainly due to a difference in selectivity between silicon dioxide (SiO₂) and silicon nitride (SiN). As such, the substructure may be different based on the number of stacked layers. The substructure formed in the semiconductor device before the etching patterns PTT1 to PTT7 are formed may affect the etching patterns PTT1 to PTT7, and an influence of this substructure may be extracted as the vertical feature.

In an embodiment, the vertical feature may include configuration information on the horizontal structure pattern HPT, included in the substructure, for each of the layout patterns LPT1 to LPT7. The configuration information on the horizontal structure pattern HPT may be expressed as a set of zeros (0) and ones (1). For example, for each of the layout patterns LPT1 to LPT7, 1 may be expressed when the horizontal structure pattern HPT exists, and zero may be expressed when the horizontal structure pattern HPT does not exist. In an example of FIG. 9, the vertical feature of the first layout pattern LPT1 may be determined as [0, 0, 0, 0, 0, 0, 0, 0, 0, 0, 0, 0, 0, 0, 0, 0, 0, 0, 0, and 0]. The vertical feature of the second layout pattern LPT2 may be determined as [0, 0, 0, 0, 0, 0, 0, 0, 0, 0, 0, 0, 0, 0, 0, 0, 1, 1, 1, and 1]. The vertical feature of the third layout pattern LPT3 may be determined as [0, 0, 0, 0, 0, 0, 0, 0, 0, 0, 0, 0, 1, 1, 1, 1, 1, 1, 1, and 1]. The vertical feature of the fourth layout pattern LPT4 may be determined as [0, 0, 0, 0, 0, 0, 0, 0, 1, 1, 1, 1, 1, 1, 1, 1, 1, 1, 1, and 1]. The vertical feature of the fifth layout pattern LPT5 may be determined as [0, 0, 0, 0, 1, 1, 1, 1, 1, 1, 1, 1, 1, 1, 1, 1, 1, 1, 1, and 1]. Each vertical feature of the sixth and seventh layout patterns LPT6 and LPT7 may be determined as [1, 1, 1, 1, 1, 1, 1, 1, 1, 1, 1, 1, 1, 1, 1, 1, 1, 1, 1, and 1].

In an embodiment, the vertical feature may include position information on a vertical position at which a composition of a material included in the substructure is changed for each of the layout patterns LPT1 to LPT7. FIG. 9 shows the heights or vertical positions h1 to h6 at which the composition of a material is changed. In the example of FIG. 9, zero may be the determined vertical feature of the first layout pattern LPT1, the first vertical position h1 may be the determined vertical feature of the second layout pattern LPT2, the second vertical position h2 may be the determined vertical feature of the third layout pattern LPT3, the third vertical position h3 may be the determined vertical feature of the fourth layout pattern LPT4, the fourth vertical position h4 may be the determined vertical feature of the fifth layout pattern LPT5, and the fifth vertical position h5 may be the determined vertical feature of each of the sixth and seventh layout patterns LPT6 and LPT7. The layout LAY may be disposed in the sixth vertical position h6.

In an embodiment, the vertical feature may include group information on the composition of a material included in the substructure for each of the layout patterns LPT1 to LPT7. In the example of FIG. 9, a first group may be the determined vertical feature of the first layout pattern LPT1 including no mold layer therebelow, and a second group may be the determined vertical feature of second to seventh layout patterns LPT2 to LPT7 each including the mold layer therebelow.

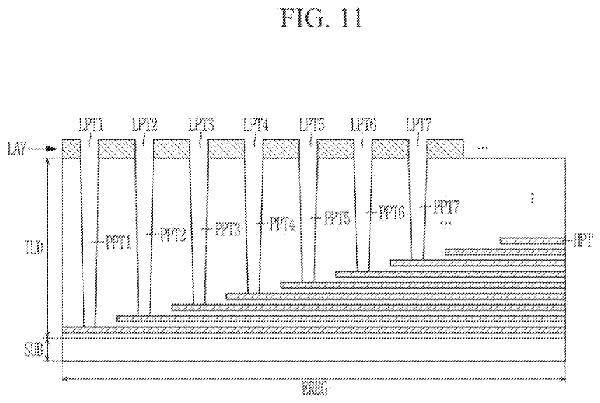

FIGS. 10 and 11 shows examples of the etching patterns PPT1 to PPT7 each having the via contact for electrically connecting the horizontal structure patterns HPT to each other. Each of the horizontal structure patterns HPT may correspond to an anti-etching film of the etching patterns PPT1 to PPT7. In this case, the position information of the vertical feature may be a vertical position of the anti-etching film. The vertical position may be expressed as the height or number of layers of the horizontal structure pattern HPT corresponding to the anti-etching film for each etching pattern.

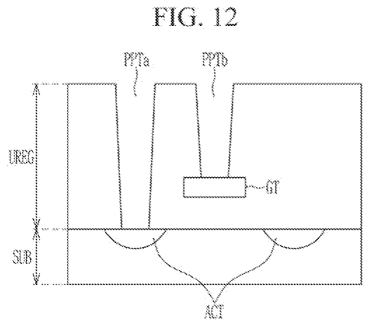

Referring to FIG. 12, active regions ACT may be formed in the semiconductor substrate SUB, and a gate GT may be formed in an upper region UREG between the active regions ACT. A first etching pattern PPTa for the via contact between the active areas ACT and a second etching pattern PPTb for the via contact between the gates GT may be formed in one etching process. Here, the active region ACT may correspond to the anti-etching film of the first etching pattern PPTa, and the gate GT may correspond to the anti-etching film of the second etching pattern PPTb. In this case, the group information of the vertical feature may show a composition of the anti-etching film.

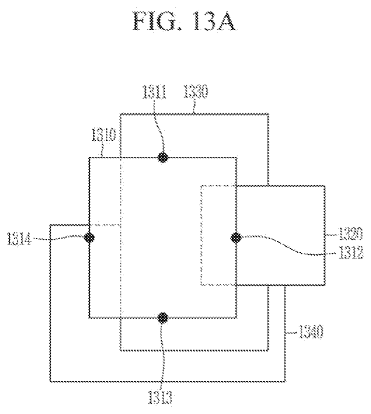

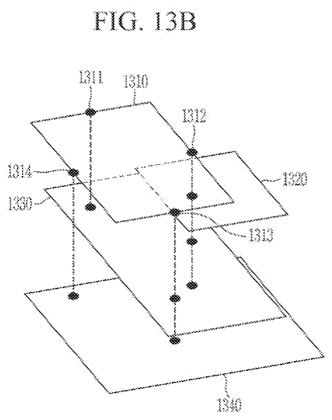

FIGS. 13A and 13B are views for explaining a configuration in which the semiconductor process module determines the vertical feature of the semiconductor device according to an example embodiment.

FIG. 13A is a plan view showing the layout and substructure of the semiconductor device, and FIG. 13B is a perspective view showing the layout and substructure of the semiconductor device. The layout is the ACI target layout, and the substructure may include the plurality of sublayers.

Referring to FIGS. 1, 13A, and 13B, the semiconductor process module 200 according to an example embodiment may obtain the design data as shown in FIGS. 13A and 13B. The semiconductor process module 200 may determine the vertical feature based on the design data. In the design data, the semiconductor device may include a layout 1310 and sublayers 1320, 1330, and 1340.

The semiconductor process module 200 may determine evaluation points 1311, 1312, 1313, and 1314 from the layout 1310. The evaluation points 1311, 1312, 1313, and 1314 may be positioned at the center of each segment of the layout 1310. For example, each of the evaluation points 1311, 1312, 1313, and 1314 may be at the center of a corresponding one of the linear segments of the layout 1310. The semiconductor process module 200 may determine whether the sublayers 1320, 1330, and 1340 exist at the vertical positions of the evaluation points 1311, 1312, 1313, and 1314. The vertical position may indicate a direction perpendicular to the layout 1310.

For example, the semiconductor process module 200 may determine that the second sublayer 1330 exists at the vertical position of the first evaluation point 1311, the first sublayer 1320, the second sublayer 1330, and the third sublayer 1340 exist at the vertical position of the second evaluation point 1312, the second sublayer 1330 and the third sublayer 1340 exist at the vertical position of the third evaluation point 1313, and the third sublayer 1340 exists at the vertical position of the fourth evaluation point 1314.

The semiconductor process module 200 may express the presence or absence of the sublayer 1320, 1330, or 1340 by using the vector. In an embodiment, a vector value may be 1 when the sublayer exists below the evaluation point and a vector value may be zero when no sublayer exists below the evaluation point. For example, the vector value for the first evaluation point 1311 may be [0, 1, 0], the vector value for the second evaluation point 1312 may be [1, 1, and 1], the vector value for the third evaluation point 1313 may be [0, 1, and 1], and the vector value for the fourth evaluation point 1314 may be [0, 0, and 1].

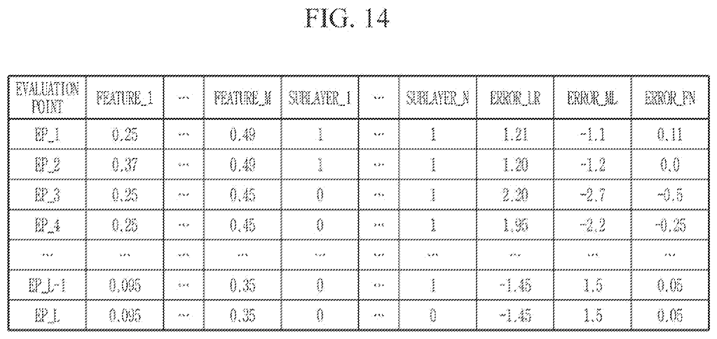

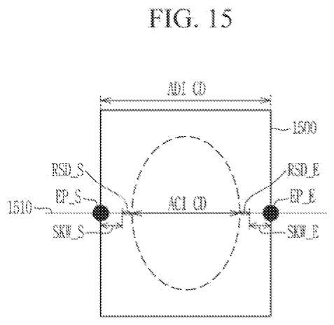

FIGS. 14 and 15 are views for explaining a configuration in which the machine learning module performs the linear regression and the machine learning according to an example embodiment.

Referring to FIGS. 1 and 14, the machine learning module 210 according to an example embodiment may obtain the lateral feature and vertical feature for each of evaluation points EP_1 to EP_L. Here, L may be an integer greater than 1. For example, the machine learning module 210 may obtain the lateral feature and the vertical feature from design data. The lateral features may include the density, visible area, width, space, length, or the like of the layout pattern, and may correspond to columns of FEATURE_1, . . . , and FEATURE_M. Here, M may be an integer greater than 1. The vertical features may include the presence or absence of the sublayer in the substructure of the layout, and correspond to columns of SUBLAYER_1, . . . , and SUBLAYER_N. Here, N may be an integer greater than 1.

The machine learning module 210 may obtain the real skew. For example, the machine learning module 210 may obtain the real skew by inspecting the actual wafer on which the semiconductor process is already performed. The machine learning module 210 may perform the linear regression and the machine learning based on the real skew, the lateral feature, and the vertical feature. The machine learning module 210 may generate the PPC model by performing the linear regression and the machine learning. The PPC model may be the feature-based etch model.

The machine learning module 210 may perform the linear regression by using Equation 1.

$$skew\_real = \sum {c}_{li} * laternal\_i + \sum {c}_{sj} * sublayer\_j \qquad ( Equation 1 )$$

Here, skew_real indicates the real skew, which is an actual difference between the ADI CD and the ACI CD for each of the evaluation points EP_1 to EP_L on the actual wafer, lateral_i indicates a value of an i-th lateral feature, Cₗᵢ indicates a coefficient for the lateral_i, sublayer_j indicates a value for whether a j-th sublayer exists, and Cₛⱼ indicates a coefficient for the sublayer_j.

The machine learning module 210 may obtain the coefficients Cₗᵢ and Cₛⱼ by using the linear regression on the real skew skew_real, the lateral feature lateral_i, and the vertical feature sublayer_j. The machine learning module 210 may calculate the predicted skew by using the lateral feature lateral_i, the vertical feature sublayer_j, and the coefficients Cₗᵢ and Cₛⱼ.

The machine learning module 210 may calculate a linear regression error ERROR_LR by using Equation 2.

$$ERROR\_LR = skew\_real - skew\_estm \qquad ( Equation 2 )$$

Here, ERROR_LR indicates the residue skew, which is an error of the linear regression, the skew_real indicates the real skew, and skew_estm indicates the predicted skew calculated using the linear regression.

The machine learning module 210 may perform the machine learning by using the lateral feature lateral_i, the vertical feature sublayer_j, and the linear regression error ERROR_LR. The machine learning module 210 may use, for the machine learning, the learning data set having the lateral feature lateral_i and the vertical feature sublayer_j as the input data and the linear regression error ERROR_LR as the output data. For example, the machine learning module 210 may include an artificial neural network that performs the machine learning, and the artificial neural network may generate a weight defining a relationship between the lateral feature lateral_i, the vertical feature sublayer_j, and the linear regression error ERROR_LR through the machine learning. The machine learning module 210 may update the coefficients Cₗᵢ and Cₛⱼ by using the artificial neural network.

The machine learning module 210 may infer the residue skew from the lateral feature lateral_i and the vertical feature sublayer_j by using the artificial neural network that completes the learning. The residue skew inferred by the machine learning module 210 may be expressed as error compensation ERROR_ML. In an embodiment, the linear regression error ERROR_LR and the error compensation ERROR_ML may have signs opposite to each other. For example, when the linear regression error ERROR_LR is a positive number, the error compensation ERROR_ML may be a negative number, and when the linear regression error ERROR_LR is the negative number, the error compensation ERROR_ML may be the positive number.

The machine learning module 210 may compensate for the predicted skew of the linear regression by using the error compensation ERROR_ML. A final error ERROR_FN is a sum of the linear regression error ERROR_LR and the error compensation ERROR_ML, and shows the difference between the skew determined by the machine learning module 210 and the real skew. It may be seen that the final error ERROR_FN has a value close to zero (0) through the linear regression and the machine learning. For example, the machine learning module 210 may generate the predicted skew and the error compensation ERROR_ML by performing the linear regression and the machine learning, and determine the skew based on the predicted skew and the error compensation ERROR_ML. The machine learning module 210 may generate the ACI prediction layout from the ADI layout based on the determined skew.

Referring to FIGS. 1 and 15, the machine learning module 210 according to an embodiment may obtain a layout pattern 1500. The machine learning module 210 may generate a line 1510 passing through a segment of the pattern 1500. For example, the line 1510 may pass through the middle of the segment. The machine learning module 210 may determine evaluation points EP_S and EP_E based on the pattern 1500 and the line 1510. The machine learning module 210 may determine contact points between the segments of the pattern 1500 and the line 1510 as the evaluation points EP_S and EP_E.

The machine learning module 210 may determine a skew in the pattern 1500. The skew determined by the machine learning module 210 may be similar to the real skew. In FIG. 15, the real skew may be expressed as the ADI CD or the ACI CD. The machine learning module 210 may simulate the real skew by determining a skew of each of the evaluation points EP_S and EP_E and summing the skews of the evaluation points EP_S and EP_E together.

The machine learning module 210 may determine predicted skews SKW_S and SKW_E of the evaluation points EP_S and EP_E by using the linear regression. The machine learning module 210 may use the linear regression for the lateral feature, the vertical feature, and the real skew. For example, the machine learning module 210 may determine the predicted skew SKW_S of the evaluation point EP_S and the predicted skew SKW_E of the evaluation point EP_E by using the linear regression. The predicted skews SKW_S and SKW_E determined by the machine learning module 210 may differ from the real skew ADI CD or ACI CD. The machine learning module 210 may calculate the residue skew based on the predicted skews SKW_S and SKW_E and the real skews ADI CD and ACI CD.

The machine learning module 210 may use the machine learning to compensate for the predicted skew. The machine learning module 210 may perform the machine learning based on the lateral feature, the vertical feature, and the residue skew. Here, the machine learning module 210 may use, for the machine learning, the learning data set having the lateral feature and the vertical feature as the input data and the residue skew as the output data. The machine learning module 210 that completes the learning may determine compensation residues RSD_S and RSD_E based on the lateral and vertical features. For example, the machine learning module 210 may determine the compensation residue RSD_S of the evaluation point EP_S and the compensation residue RSD_E of the evaluation point EP_E.

The machine learning module 210 may determine the predicted skews SKW_S and SKW_E and the compensation residues RSD_S and RSD_E by using the linear regression and the machine learning. The machine learning module 210 may effectively simulate the real skew ADI CD or ACI CD by determining the skew by summing the predicted skews SKW_S and SKW_E and the compensation residues RSD_S and RSD_E together. The machine learning module 210 may update the weight by using an additional learning data set. For example, the machine learning module 210 may more accurately simulate the real skew ADI CD or ACI CD through additional learning. The machine learning module 210 may determine the ACI layout based on the determined skew.

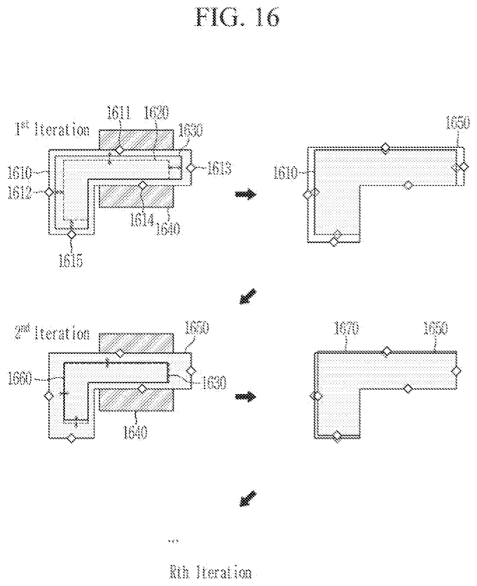

FIG. 16 is a view for explaining the operation of the correction module according to an example embodiment.

Referring to FIG. 1, the correction module 220 according to an example embodiment may perform the PPC by using the PPC model generated by the machine learning module 210. The correction module 220 may generate the ADI layout by performing the PPC on the ACI target layout. A pattern different from that in the ACI target layout may be formed when the semiconductor process is performed by using the initial ADI layout generated by the correction module 220. Accordingly, the correction module 220 may correct the ADI layout so that the ACI target layout is obtained during the semiconductor process. The correction module 220 may correct the ADI layout by using the PPC model. The PPC model may generate the ACI prediction layout from the ADI layout.

Referring to FIG. 16, the correction module 220 may obtain an initial ADI layout 1610. In an embodiment, the correction module 220 may obtain the initial ADI layout 1610 from an ACI target layout 1630. The correction module 220 may generate evaluation points 1611, 1612, 1613, 1614, and 1615 on segments of the initial ADI layout 1610. The correction module 220 may generate the evaluation point 1611, 1612, 1613, 1614, or 1615 at the center of each segment of the initial ADI layout 1610. For example, each of the evaluation point 1611, 1612, 1613, 1614, or 1615 may be at the center of a corresponding one of the linear segments of the initial ADI layout 1610.

The correction module 220 may use the PPC model generated based on the lateral and vertical features of the evaluation points 1611, 1612, 1613, 1614, and 1615. For example, each of the evaluation points 1611 and 1614 may have the vertical feature that a sublayer 1640 exists therebelow. Each of the evaluation points 1612, 1613, and 1615 may have the vertical feature that the sublayer 1640 does not exist therebelow.

The correction module 220 may generate an ACI prediction layout 1620 from the initial ADI layout 1610 by using the PPC model. The ACI prediction layout 1620 may differ from the ACI target layout 1630. The difference may be a separation distance between the ACI prediction layout 1620 and the ACI target layout 1630, and may be different for each segment. For example, the ACI target layout 1630 may include first to fifth segments. The difference between the ACI prediction layout 1620 and the ACI target layout 1630 may include a first difference in the first segment, a second difference in the second segment, a third difference in the third segment, a fourth difference in the fourth segment, and a fifth difference in the fifth segment.

The correction module 220 may correct the initial ADI layout 1610 based on the difference. The correction module 220 may correct positions of the segments of the initial ADI layout 1610 and positions of the evaluation points 1611, 1612, 1613, 1614, and 1615. An iteration may indicate a process in which the correction module 220 detects the difference between the ACI prediction layout 1620 and the ACI target layout 1630, and corrects the initial ADI layout 1610 based on the difference. The correction module 220 may generate an ADI layout 1650 by performing a first iteration.

In an embodiment, the correction module 220 may correct the initial ADI layout 1610 by a value corresponding to the difference between the ACI prediction layout 1620 and the ACI target layout 1630. In another embodiment, the correction module 220 may correct the initial ADI layout 1610 by a value obtained by multiplying the difference by a factor. The factor may be a decimal greater than zero and less than 1. In still another example, the correction module 220 may correct the ADI layouts 1610, 1650, and 1670 by using a different factor for each iteration. For example, the correction module 220 may use a first factor in the first iteration, a second factor in a second iteration, and an R-th factor in an R-th iteration. Here, R may be an integer greater than 2. A value of the factor may be smaller as the iterations progress. For example, the second factor may be smaller than the first factor, the third factor may be smaller than the second factor, and the R-th factor may be smaller than an R−1-th factor.

The correction module 220 may perform the second iteration. The correction module 220 may generate an ACI prediction layout 1660 from the ADI layout 1650 by using the PPC model. The ACI prediction layout 1660 may differ from the ACI target layout 1630. The correction module 220 may generate an ADI layout 1670 by correcting the ADI layout 1650 based on the difference.

The correction module 220 may repeatedly perform the iterations until the difference between the ACI prediction layout generated by the correction module 220 and the ACI target layout 1630 has a value less than a threshold value. The correction module 220 may perform the OPC by using the ADI layout in which the difference between the ACI prediction layout and the ACI target layout 1630 is less than the threshold value.

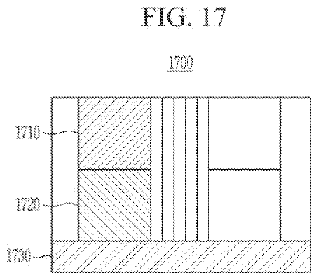

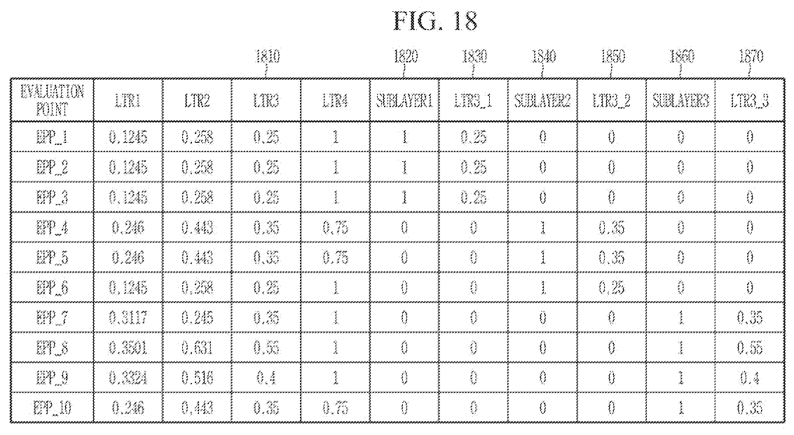

FIGS. 17 and 18 are views for explaining a configuration in which the machine learning module performs the linear regression and the machine learning according to an example embodiment.

Referring to FIGS. 1 and 17, the semiconductor device may be manufactured to have a different pattern based on a design, and may have an irregular substructure 1700. For example, a pattern in the substructure 1700 may have a different shape and different density, or have each area having a different characteristic. The substructure 1700 may include a plurality of sublayers such as sublayers 1710, 1720, and 1730.

The machine learning module 220 according to an embodiment may divide the substructure and select at least one sublayer from the plurality of sublayers. The machine learning module 220 may determine the lateral feature operated only on the selected sublayer. The machine learning module 220 may learn a relationship between the determined lateral feature and the selected sublayer. The machine learning module 220 may generate the PPC model as a result of performing the linear regression and the machine learning.

Accordingly, the machine learning module 220 may perform sophisticated modeling by dividing the substructure 1700 into the plurality of areas and performing the machine learning only on a specific area, rather than performing the machine learning on the entire substructure 1700.

Referring to FIG. 18, the machine learning module 210 may obtain the lateral features LTR1 to LTR4 and vertical features SUBLAYER1 to SUBLAYER3 of evaluation points EPP_1 to EPP_10. For example, the machine learning module 210 may obtain the lateral features LTR1 to LTR4 and the vertical features SUBLAYER1 to SUBLAYER3 from the design data. The lateral features LTR1 to LTR4 may include the density, visible area, width, space, length, and the like of the pattern in the layout. The vertical features SUBLAYER1 to SUBLAYER3 may include presence or absence of the sublayers 1710, 1720, and 1730 in the substructure 1700. The vertical feature SUBLAYER1 may correspond to the sublayer 1710, the vertical feature SUBLAYER2 may correspond to the sublayer 1720, and the vertical feature SUBLAYER3 may correspond to the sublayer 1730. Vertical lines of the evaluation points EPP_1 to EPP_3 may pass through the sublayer 1710, vertical lines of the evaluation points EPP_4 to EPP_6 may pass through the sublayer 1720, and vertical lines of the evaluation points EPP_7 to EPP_10 may pass through the sublayer 1730.

The machine learning module 210 may determine one lateral feature LTR3 among the lateral features LTR1 to LTR4, and select a sublayer on which the lateral feature LTR3 is operated.

In an embodiment, the machine learning module 210 may select the sublayer 1710 on which the lateral feature LTR3 is operated. The machine learning module 210 may generate a column 1830 by multiplying a column 1810 corresponding to the lateral feature LTR3 and a column 1820 corresponding to the sublayer 1710. The column 1820 may have the value of 1 for the evaluation points EPP_1 to EPP_3 and the value of zero for the evaluation points EPP_4 to EPP_10. Accordingly, the column 1830 may include information on the lateral feature LTR3 operated on the evaluation points EPP_1 to EPP_3. The machine learning module 210 may perform the machine learning by replacing the column 1810 with the column 1830. Accordingly, the machine learning module 210 may learn a relationship between the lateral feature LTR3 and the sublayer 1710.

In an embodiment, the machine learning module 210 may select the sublayer 1720 on which the lateral feature LTR3 is operated. The machine learning module 210 may generate a column 1850 by multiplying the column 1810 corresponding to the lateral feature LTR3 and a column 1840 corresponding to the sublayer 1720. The column 1840 may have the value of zero for the evaluation points EPP_1 to EPP_3 and the value of 1 for the evaluation points EPP_4 to EPP_6. Accordingly, the column 1850 may include information on the lateral feature LTR3 operated on the evaluation points EPP_4 to EPP_6. The machine learning module 210 may perform the machine learning by replacing the column 1810 with the column 1850. Accordingly, the machine learning module 210 may learn a relationship between the lateral feature LTR3 and the sublayer 1720.

In an embodiment, the machine learning module 210 may select the sublayer 1730 on which the lateral feature LTR3 is operated. The machine learning module 210 may generate a column 1870 by multiplying the column 1810 corresponding to the lateral feature LTR3 and a column 1860 corresponding to the sublayer 1730. The column 1860 may have the value of zero for the evaluation points EPP_1 to EPP_6 and the value of 1 for the evaluation points EPP_7 to EPP_10. Accordingly, the column 1870 may include information on the lateral feature LTR3 operated on the evaluation points EPP_7 to EPP_10. The machine learning module 210 may perform the machine learning by replacing the column 1810 with the column 1870. Accordingly, the machine learning module 210 may learn a relationship between the lateral feature LTR3 and the sublayer 1730.

The above-described examples describe a configuration in which the machine learning module 210 learns one sublayer 1710, 1720, or 1730 and the lateral feature LTR3. However, the present disclosure is not necessarily limited thereto, and the machine learning module 210 may be implemented as learning the lateral features LTR3 in combination with the plurality of sublayers.

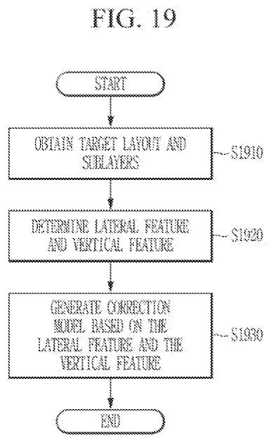

FIG. 19 is a flowchart of a process model generating method according to an example embodiment.

Referring to FIG. 19, the process model generating method according to another embodiment may be performed by a computing device. For example, the process model generating method of FIG. 19 may be performed by the computing device 100 of FIG. 1. A process model may be a feature-based etch model for process proximity correction (PPC).

The computing device 100 may obtain a target layout for a process of a semiconductor device and a plurality of sublayers representing a substructure of the semiconductor device (S1910). The target layout may be an after-cleaning inspection (ACI) target layout. The computing device 100 may obtain the target layout and the plurality of sublayers from design data.

The computing device 100 may determine the lateral feature and vertical feature of the target layout (S1920). The computing device 100 may generate an evaluation point on the target layout. For example, the computing device 100 may generate the evaluation point at the center of a segment of a pattern in the target layout. For example, the computing device 100 may generate the evaluation point at the center of a linear segment of a pattern in the target layout. The number of evaluation points may be less than or equal to the number of segments of the pattern.

The computing device may determine the lateral feature and vertical feature of the evaluation point. The lateral feature is a feature of the evaluation point for the target layout, and the vertical feature may include information on the sublayer in contact with a vertical line of the evaluation point for the target layout among the plurality of sublayers.

The computing device 100 may determine the vertical feature by using a vector value of zero or 1. For example, the computing device 100 may determine 1 as a vector value of the sublayer in contact with the vertical line among the plurality of sublayers, and determine zero as a vector value of the sublayer in non-contact with the vertical line among the plurality of sublayers.

In another embodiment, the computing device 100 may divide and manage the plurality of sublayers. For example, the computing device 100 may determine the sublayer on which the lateral feature is operated among the plurality of sublayers. The computing device 100 may update the lateral feature based on the determined sublayer.

The computing device 100 may generate a correction model for the target layout based on the lateral feature and the vertical feature (S1930). The computing device 100 may generate a prediction layout from an initial layout by using the correction model. The initial layout may be generated in advance from the target layout.

The computing device 100 may generate a first model by using linear regression on the lateral feature and the vertical feature. For example, the computing device 100 may obtain a real skew of the target layout, and perform the linear regression on the real skew, the lateral feature, and the vertical feature. Here, the real skew may be a difference between an after-development inspection (ADI)-critical dimension (CD) and an after-cleaning inspection (ACI)-critical dimension (CD). The computing device 100 may generate the first model by obtaining coefficients Cₗᵢ and Cₛⱼ of Equation 1 by using the linear regression.

The computing device 100 may generate a second model by using machine learning on the first model. The computing device 100 may calculate a predicted skew from the lateral feature and the vertical feature by using the first model. The computing device 100 may calculate a first residue skew that is a difference between the real skew and the predicted skew. The computing device 100 may perform the machine learning by using the lateral feature, the vertical feature, and the first residue skew. Here, the lateral feature and the vertical feature may be input data of a learning data set, and the first residue skew may be output data of the learning data set.

The computing device 100 may infer a second residue skew by using the second model. The computing device 100 may determine a final skew based on the predicted skew and the second residue skew. The computing device 100 may generate the prediction layout for the target layout based on the target layout and the final skew. The computing device 100 may determine a separation distance between the prediction layout and the target layout.

The computing device 100 may correct the initial layout based on the separation distance. For example, the computing device 100 may perform the correction when the separation distance between the prediction layout and the target layout has a value greater than a threshold value.

In another embodiment, the computing device 100 may correct position of the segment in the initial layout and position of the evaluation point by the separation distance.

In another embodiment, the computing device 100 may correct the position of the segment in the initial layout and the position of the evaluation point based on a value obtained by multiplying the separation distance by a predetermined factor. Here, the predetermined factor may be a decimal less than 1.

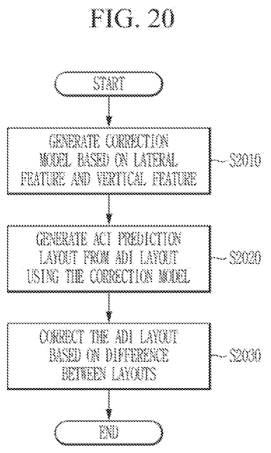

FIG. 20 is a flowchart of a process proximity correction method according to an example embodiment.

Referring to FIG. 20, the process proximity correction method according to still another embodiment may be performed by a computing device. For example, the process model generating method of FIG. 20 may be performed by the computing device 100 of FIG. 1. The computing device 100 may perform process proximity correction (PPC) by using a process proximity correction (PPC) model.

The computing device 100 may generate a correction model based on the lateral feature and vertical feature of an after-cleaning inspection (ACI) target layout (S2010). Here, the vertical feature may be associated with the presence or absence of a sublayer in a substructure.

The computing device 100 may determine a first value as a vector value of the vertical feature when the sublayer corresponding to the target layout exists in the substructure, and determine a second value as the vector value of the vertical feature when no sublayer corresponding to the target layout exists in the substructure. In still another embodiment, the first value may be 1 and the second value may be zero. For example, the computing device may express the vertical feature by using a vector value of zero or 1.

The computing device 100 may generate the correction model by performing linear regression and machine learning on the lateral feature and the vertical feature. For example, the computing device 100 may perform the machine learning after performing the linear regression on the lateral feature and the vertical feature.

The computing device 100 may generate an ACI prediction layout from an after-development inspection (ADI) layout by using the correction model (S2020). The ACI prediction layout may differ from the ACI target layout.

The computing device 100 may correct the ADI layout based on a first difference between the ACI prediction layout and the ACI target layout (S2030). In still another embodiment, the computing device 100 may generate a first corrected layout by correcting the ADI layout based on a value obtained by multiplying the first difference by a first factor. The computing device 100 may then obtain a second difference between the ACI target layout and the first corrected layout, and generate a second corrected layout by correcting the first corrected layout based on a value obtained by multiplying the second difference by a second factor. Here, the second factor may be smaller than the first factor.

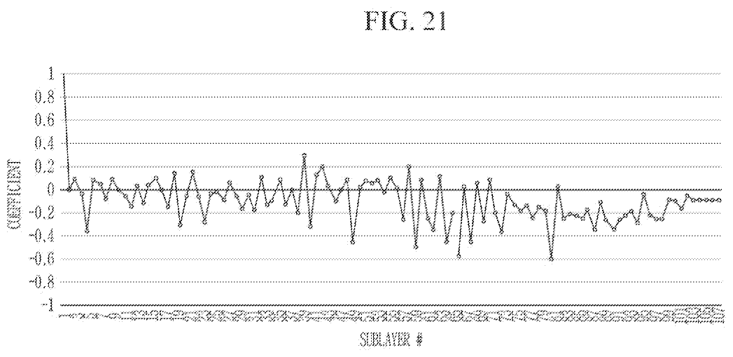

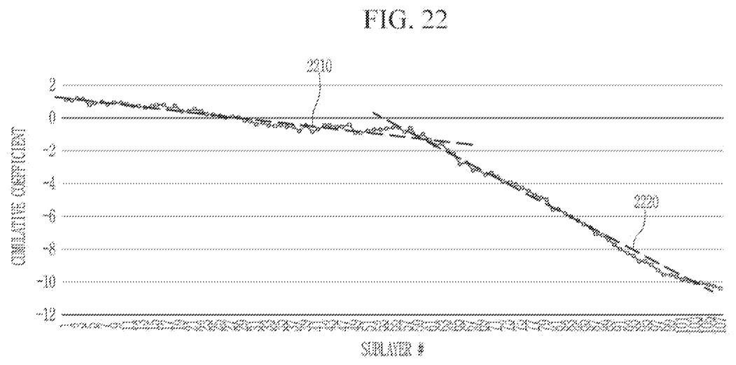

FIGS. 21 and 22 show graphs for explaining an effect of the machine learning module according to an example embodiment.

FIG. 21 is a graph showing the vertical features sublayer_j and coefficients Cₛⱼ of Equation 1, which are obtained through the linear regression and the machine learning by the machine learning module 210 according to an example embodiment. The semiconductor device may include the plurality of sublayers, and each sublayer may have the different coefficient Cₛⱼ.

FIG. 22 is a graph showing the cumulative coefficients Cₛⱼ of FIG. 21. It may be seen that referring to an auxiliary line 2210, all the sublayers from a first sublayer (or the uppermost sublayer closest to the layout) to an X sublayer have a first inclination, and referring to an auxiliary line 2220, all the sublayers from the X sublayer to a Y sublayer (or the lowest sublayer farthest away from the layout) have a second inclination. For example, X may be 55 and Y may be 107. The second inclination may be greater than the first inclination.

Referring to FIGS. 21 and 22, it is possible to analyze a process characteristic based on the substructure by analyzing the coefficients Cₛⱼ of the learned PPC model. For example, it is possible to analyze an influence on the skew caused by each sublayer by analyzing the coefficient Cₛⱼ.

For example, in the substructure of the semiconductor device, the sublayers from the first sublayer to the X sublayer may have an additional skew contribution of the first inclination, and the sublayers from the X sublayer to the Y sublayer may have a greater skew contribution of the second inclination. For example, it may be seen that the sublayers from the first sublayer to the X sublayer have a lower skew dependency on the substructure, and the sublayers from the X sublayer to the Y sublayer have a greater skew dependence on the substructure. The data may be used to optimize the entire semiconductor process such as an overall process of patterning in addition to the PPC and the OPC.

FIG. 23 is flowchart illustrates a method of manufacturing semiconductor device using a photomask optimized according to example embodiments. First, in step 2310, an optimized photomask formed by the optimization method disclosed herein may be provided to a location where semiconductor manufacturing is performed. For example, the photomask may be moved via a loading device (e.g., using an electro-mechanical device connected to a holder such as a hand-gripper, in a manner that allows the mask to be picked up and/or moved) into equipment that uses the photomask for photolithography.

Next, in step 2320, the photomask may be used to perform a step in forming an integrated circuit device such as a semiconductor wafer. For example, the photomask may be placed in a chamber where a semiconductor wafer is disposed, and may be used for a photolithography process to form a pattern on the semiconductor wafer. Subsequently, additional steps may be performed on the wafer, for example to form a semiconductor device (step 2330). For example, additional layers may be deposited on the wafer to form semiconductor chips, the semiconductor chips may then be singulated, packaged on a package substrate, and encapsulated by an encapsulant to form a semiconductor device.

The above steps may be controlled by a control system including one or more computers and one or more electro-mechanical devices for moving a travelling part within a transferring apparatus. Also, though the above steps are described in a particular order, they need not occur in that order necessarily.

In some embodiments, each component or more components in combination, described with reference to FIGS. 1 through 23, may be implemented in a digital circuit, a programmable or non-programmable logic device, a programmable or non-programmable array, an application specific integrated circuits (ASIC), etc.

Although the embodiments of the present disclosure have been described in detail hereinabove, the scope of the invention is not limited thereto. That is, various modifications and alterations made by those skilled in the art by using concepts of the present disclosure as defined in the following claims also fall within the scope of the invention.

What is claimed is:

1. A process model generating method, the method comprising:
obtaining a target layout for a process of manufacturing a semiconductor device and a plurality of sublayers representing a substructure of the semiconductor device;
determining a lateral feature and a vertical feature of the target layout; and
generating a correction model for the target layout based on the lateral feature and the vertical feature.

2. The method of claim 1, wherein the determining of the lateral feature and the vertical feature of the target layout includes:
generating an evaluation point on the target layout; and
determining the lateral feature and the vertical feature of the evaluation point.

3. The method of claim 2,
wherein the lateral feature is a feature of the evaluation point for the target layout, and
wherein the vertical feature includes information on a sublayer in contact with a vertical line of the evaluation point for the target layout among the plurality of sublayers.

4. The method of claim 3, wherein the determining of the lateral feature and the vertical feature of the evaluation point includes:
determining a vector value of the sublayer in contact with the vertical line among the plurality of sublayers as 1, and determining a vector value of a sublayer not in contact with the vertical line among the plurality of sublayers as 0.

5. The method of claim 2, wherein the generating of the evaluation point includes:
generating at least one evaluation point at a center of at least one segment of a pattern in the target layout,
wherein a number of the at least one evaluation point is less than or equal to a number of the at least one segment of the pattern.

6. The method of claim 1, wherein the generating of the correction model includes:
generating a first model by using linear regression on the lateral feature and the vertical feature; and
generating a second model by using machine learning on the first model.

7. The method of claim 6, wherein the generating of the first model includes:
obtaining a real skew of the target layout; and
performing the linear regression on the real skew, the lateral feature, and the vertical feature,
wherein the real skew is a difference between an after-development inspection-critical dimension (ADI-CD) and an after-cleaning inspection-critical dimension (ACI-CD).

8. The method of claim 7, wherein the generating of the first model includes:
generating the first model by obtaining coefficients Cₗᵢ and Cₛⱼ of the following Equation by using the linear regression:
$$skew\_real = \sum {c}_{li} * laternal\_i + \sum {c}_{sj} * sublayer\_j$$
wherein skew_real is the real skew, lateral_i is a value of an i-th lateral feature, Cₗᵢ is a coefficient for the lateral_i, sublayer_j is a value for whether a j-th sublayer exists among the plurality of sublayers, and Cₛⱼ is a coefficient for the sublayer_j.

9. The method of claim 7,
wherein the generating of the second model includes:
calculating a predicted skew from the lateral feature and the vertical feature by using the first model;
calculating a first residue skew that is a difference between the real skew and the predicted skew; and
performing the machine learning by using the lateral feature, the vertical feature, and the first residue skew,
wherein the lateral feature and the vertical feature are input data of a learning data set, and the first residue skew is output data of the learning data set.

10. The method of claim 9, further comprising:
inferring a second residue skew by using the second model;
determining a final skew based on the predicted skew and the second residue skew; and
generating a prediction layout for the target layout based on the target layout and the final skew.

11. The method of claim 1, further comprising:
generating a prediction layout from an initial layout by using the correction model;
determining a separation distance between the prediction layout and the target layout; and
correcting the initial layout based on the separation distance.

12. The method of claim 11, wherein the correcting of the initial layout includes:
performing correction when the separation distance between the prediction layout and the target layout has a value greater than or equal to a threshold value.

13. The method of claim 11, wherein the correcting of the initial layout includes:
correcting a position of the segment in the initial layout and a position of the evaluation point based on the separation distance.

14. The method of claim 13,
wherein the correcting of the initial layout includes correcting the position of the segment in the initial layout and the position of the evaluation point based on a value obtained by multiplying the separation distance by a predetermined factor, and
wherein the predetermined factor is a decimal less than 1.

15. The method of claim 1, wherein the determining of the lateral feature and the vertical feature of the target layout includes:
determining the sublayer on which the lateral feature is operated among the plurality of sublayers; and
updating the lateral feature based on the determined sublayer.

16. A process proximity correction method, the method comprising:
generating a correction model based on a lateral feature and a vertical feature of an after-cleaning inspection (ACI) target layout;
generating an ACI prediction layout from an after-development inspection (ADI) layout by using the correction model; and
correcting the ADI layout based on a first difference between the ACI prediction layout and the ACI target layout,
wherein the vertical feature is associated with a presence or an absence of a sublayer in a substructure.

17. The method of claim 16, wherein the generating of the correction model includes:
determining a vector value of the vertical feature as a first value when the sublayer corresponding to the target layout exists in the substructure, and determining a vector value of the vertical feature as a second value different from the first value when no sublayer corresponding to the target layout exists in the substructure.

18. The method of claim 16, wherein the generating of the correction model includes:
generating the correction model by performing linear regression and machine learning on the lateral feature and the vertical feature.

19. The method of claim 16, wherein the correcting of the ADI layout includes:
generating a first corrected layout by correcting the ADI layout based on a value obtained by multiplying the first difference by a first factor;
obtaining a second difference between the ACI target layout and the first corrected layout; and
generating a second corrected layout by correcting the first corrected layout based on a value obtained by multiplying the second difference by a second factor,
wherein the second factor is smaller than the first factor.

20. A computing device comprising a plurality of processors,
wherein at least one of the plurality of processors generates a correction model for process proximity correction, and
wherein when the at least one of the plurality of processors generates the correction model for the process proximity correction, the at least one of the plurality of processors generates is configured to:
obtain a target layout for a process of manufacturing a semiconductor device and a plurality of sublayers representing a substructure of the semiconductor device;
determine a lateral feature and a vertical feature of the target layout; and
generate the correction model based on the lateral feature and the vertical feature.
